(19) United States
(12) Patent Application Publication
(10) Pub. No.: US 2015/0088780 A1
(43) Pub. Date: Mar. 26, 2015

(54) DYNAMIC ROUTE PLANNING

(71) Applicant: Boris Paul, Bonn (DE)

(72) Inventor: Boris Paul, Bonn (DE)

(73) Assignee: Deutsche Post AG, Bonn (DE)

(21) Appl. No.: 13/989,066

(22) PCT Filed: Nov. 17, 2011
(86) PCT No.: PCT/EP2011/070309

§ 371 Date: May 23, 2013

(30) Foreign Application Priority Data
Nov. 24, 2010 (DE) 102010061901.9

(51) Int. Cl. G06Q 10/08

(52) U.S. Cl. CPC G06Q 10/08355
USPC 705/338

(57) ABSTRACT

A system for route planning and loading transport vehicles comprises a computer having a database with shipment data allocated to objects for transport. The computer uses the shipment data per object for each transport vehicle to generate a first route plan for object delivery on a transport date. A conveyor belt conveys objects according to the route plan to the allocated transport vehicles. A checking station checks for a route plan for passing objects and signals an error if there is no route plan. A recognition station uses the error signal to indicate new shipment data to the computer. The computer allocates the object with the new data to an appropriate vehicle, during conveyance to the transport vehicles, and converts the first route plan for the transport vehicle into a second route plan considering the new shipment data.

### TECHNICAL FIELD OF THE INVENTION

This invention relates to a system for route planning for transport vehicles and for loading the transport vehicles with objects to be transported, as well as a corresponding method for operating the system.

### BACKGROUND OF THE INVENTION

Route planning is performed in a plurality of fields related to the distribution of goods and/or the calling on multiple destination addresses (or delivery addresses), and comprises determining an optimal sequence in which the destination addresses are to be served where certain orders are to be dispatched. One example of a field where route planning is very important is delivery and collecting parcels and other mail, for which once or several times per day, transport vehicles run trips comprising orders for varying addressees.

Route planning is performed in particular by taking into account the addresses to be served on the trips. The input quantities of route planning are in particular the distances between the respective destination addresses and the logistics center where the delivery vehicles are deployed. The distances are specified e.g. in a distance matrix which is optimized for carrying out the actual route planning, and a route plan is created for each transport vehicle.

From DE 10 2004 019 232 B4, a method for route and itinerary planning is apparent wherein in particular the determination of the sequence of the addresses to which objects are to be delivered and/or collected is done for the trips to be planned respectively according to geographical data.

According to the route plan, the objects to be transported are assigned to the respective transport vehicles and then loaded thereon. It may then happen that between objects having an already existing route plan (planned objects), a considerable amount of objects is conveyed to the transport vehicles for which there is no route plan (unplanned objects). Such unplanned objects interfere with the optimal process flow as they may be loaded into transport vehicles for the route plan of which the unplanned objects have inconvenient destination addresses so that the transport vehicle would have to follow a non optimal transport itinerary for delivering the planned and unplanned objects. Maybe the transport vehicles, to which the unplanned objects are conveyed, are already fully loaded. Possibly, the unplanned objects must be manually removed from the loading station which may imply a large amount of work. Therefore, some loading systems will prematurely sort out unplanned objects at appropriate locations. In this case, unplanned objects must also be buffered as they can only be taken into account in the next route plan. This again will result in high logistic effort. In both instances, the distribution of the unplanned objects is delayed, which is undesirable from a customer's point of view, and moreover uses unnecessary resources.

### SUMMARY OF THE INVENTION

The object of this invention is to provide a system allowing for dynamic route planning for unplanned objects to be taken into account in existing logistics processes.

This object is solved by a system for route planning for transport vehicles and for loading the transport vehicles with objects to be transported, the system comprising a computer system having a database with shipment data allocated to the objects to be transported, the computer system creating for each transport vehicle by means of the shipment data allocated to the objects an allocated first route plan for the objects to be delivered on a date of delivery with the respective transport vehicle, and the system comprising a means of conveyance, preferably a conveyor belt, conveying the objects to be transported according to the route plan to the allocated transport vehicles, characterized in that the system further includes a checking station and a recognition station, wherein the checking station is provided for checking whether a first route plan exists for the respective objects passing through the checking station while they are being conveyed to the transport vehicles, and which is provided, in the event of a non-existent first route plan, for emitting a corresponding error signal, in that the recognition station is provided for detecting, based on the error signal, the shipment data for the object involved without a first route plan by means of appropriate detecting means, and transmitting such newly detected shipment data to the computer system, and in that the computer system is provided for allocating the object with newly detected shipment data to an appropriate transport vehicle while it is being conveyed with the means of conveyance to the transport vehicles, and for converting, in accordance with the transmitted new shipment data, the first route plan for this transport vehicle into a second route plan in which the object with newly detected shipment data is taken into account.

This system avoids the disadvantages of prior art, and by means of dynamic route planning taking into account unplanned objects results in an unperturbed process flow, reduced effort in conveying the objects, an optimized transport itinerary when delivering planned and unplanned objects, and thus faster distribution of the objects to the customers.

Herein, route planning designates a fixed sequence of addresses (e.g., delivery or destination addresses) at least for the respective objects existing in the transport vehicle. According to the route plan, the driver of the transport vehicle will visit the delivery addresses of the respective objects and deliver the corresponding objects at the respective delivery addresses until the last delivery address of the route plan has been reached, and the last object has been delivered. Furthermore, a route plan may include one or more pick-up addresses where the driver of the transport vehicle, in addition to distributing the objects, or without distributing any objects, will also pick up new objects, e.g. for taking them back to the logistics center where the transport trip started out. The route plan created for the planned objects prior to loading of the transport vehicle is called the first route plan. Herein, the term “transport vehicle” comprises all possible means of transportation allowing for objects to be delivered to addresses, and is not limited to motor vehicles only. Alternative transport vehicles may be for instance bicycles, ships, airplanes, etc.

The term objects designates any kind of item which can be delivered to a delivery address. Examples for such objects are mail items, in particular letters, parcels, or small parcels. In terms of the present invention, planned objects herein designate objects for which a first route plan exists. On the other hand, objects without a first route plan are unplanned objects.

The term “shipment data” includes any kind of data which is required or useful for distributing an object along the logistics chain (from submission of the object to successful distribution thereof). Shipment data is in particular one or several items of the following information: sender, invoice recipient, recipient, contact person of the sender, the recipient, or of the invoice recipient, details on the content of the shipment, details on features of the shipment (e.g., size, weight, fragility, etc.), information on desired additional services (e.g., special time of delivery), as well as shipment identification details. Herein, shipment data is allocated to the relevant object in a database, i.e. shipment data is saved as data in the database and allocated to the object via an appropriate data connection. Such a data connection may be for instance a data link or can be embodied in tabular form as a data row. For instance, if the object is identified with an object identifying detail anywhere in the system, then all of the shipment data existing in the database for this object is to be retrieved or provided by the database (upon request or automatically when an object is identified anywhere).

The objects are transported by a means of conveyance from a storage area, e.g., a high-rise warehouse, to the transport vehicles planned by the computer system according to the first route plan. A suitable means of conveyance can be for instance a conveyor belt, wherein the term “conveyor belt” also includes for instance a complete system consisting of several separate conveyor belts. Within the scope of present invention, a person skilled in the art may also choose other means of conveyance.

The checking station includes any kind of station suitable for determining whether checked objects are taking into account in a first route plan or not. E.g., in one embodiment, for this purpose, the checking station may receive all of the first route plans from the computer system via a data connection (e.g., a data cable or a wireless data connection such as WLAN for example) prior to loading the transport vehicles. For this purpose, the checking station includes a data store and a processor unit carrying out a comparison between route plans (including relevant objects) and the respective checked object. In another embodiment, the checking station may for instance be connected via a data connection (e.g., a data cable or a wireless data connection such as WLAN for example) to the computer system, whereby each checking result regarding the corresponding object is transmitted to the computer system. Next, the computer system checks the first route plans for the object involved and notifies the checking station as to whether the object involved has been taken into account in one of the first route plans or not. For the objects conveyed to the transport vehicles to be checked by the checking station, all objects must pass by the checking station on their way to the transport vehicles. E.g., for a conveyor belt as the means of conveyance, this could be done by arranging the checking station in or at the conveyor belt. A non-mobile checking station is then arranged in the conveyor belt. Herein, the conveyor belt may go through the checking station. Alternatively, the checking station may also be made so as to be mobile, e.g. as a mobile hand scanner operated by the personnel at the conveyor belt. In this case, the checking station is arranged at the conveyor belt. The checking station comprises appropriate means for recognizing the object to be checked. Such means can be for instance a barcode scanner. In the scope of the present invention, a person skilled in the art may also choose other appropriate means, e.g. RFID readers. The objects must bear the corresponding appropriate features for the readers so as to be read as part of the check.

The error signal in case of an unplanned object can be sent via a data connection (e.g. a data cable or a wireless data connection, such as WLAN for example) directly either to the recognition station and/or the computer system for further treatment including transfer to the recognition station. In one embodiment, the error signal can also be emitted optically, acoustically, or in another form in the area of the means of conveyance. A person skilled in the art is capable of appropriately choosing the data format of the control signal within the scope of the present invention. E.g., the error signal may be a start signal for a subsequent recognition procedure by the recognition station.

The recognition station includes any kind of stations suitable for detecting shipment data. For this purpose, the recognition station may include suitable detecting means, e.g. one or more OCR scanners enabling text or optical character recognition for the shipment data located on the object. Thereby, e.g. handwritten delivery and sender addresses can be read and converted into electronic data files and transmitted. Shipment data newly detected at the recognition station is transmitted via a data connection (e.g., a data cable or a wireless data connection, such as WLAN for example) to the computer system. If it is not possible for the shipment data to be detected by the recognition station, then the object can be sorted out, e.g. at the recognition station, from the means of conveyance, e.g. via a sorting belt or a sorting device. Determining shipment data for such a sorted-out object can be performed (if possible) differently.

The transmitted shipment data is processed by the computer system so that the existing first route plans are checked for the possibility of adding further objects. For transport vehicles, which are already fully loaded due to the existing route plan, or about to be fully loaded, the unplanned object involved can no longer be integrated into a second route plan for this transport vehicle. In case the transport vehicles still have some free capacity, for a suitable transport vehicle, the object is conveyed to this transport vehicle and the previous first route plan for this transport vehicle is converted into a second route plan, now with the previously unplanned object. After conversion, the previously unplanned object is now a planned object. This dynamic route re-planning has to take place while the objects are being conveyed to the transport vehicles. Typical conveying times on the means of conveyance only amount to a couple of minutes. For this to be done in due time, it is advantageous for the checking and recognition stations to be arranged at an early point of conveyance in the means of conveyance, e.g. at the beginning of the means of conveyance near the storage area for the objects or near an object loading zone for the means of conveyance.

Herein, the computer system may include one or more computers or servers. The computer system can be connected to other logistics centers and the databases with shipment data thereof, as well as to other external databases. Among others, the system can be a web-based system with access to the Internet. The data connections within the system and/or the computer system can be established via appropriate data cables or wireless data connections (e.g. WLAN).

In one embodiment, the objects include together with the allocated first route plan a corresponding machine readable route label to be read by the checking station. This route label can be for instance a barcode or RFID tag glued to or printed on the object. For attaching the route label, the inventive system may include a labeling unit creating the route label allocated to the objects and/or applying them to the objects. The computer system is connected to the labeling unit via an appropriate data connection and transmits at least the first route plans to the labeling unit for creating the route label. Herein, the information contained in the route label may designate among others the allocated transport vehicles.

In one embodiment, the detecting means is at least one reading unit for optical character recognition and/or barcode recognition. In a preferred embodiment, the recognition station includes several reading units, wherein the reading units are arranged so that optical character and/or barcodes can be recognized on all sides of the object. As the shipment data is not necessarily located on the top of a conveyed object, it must be possible to detect also the other sides of the object. For this purpose, it is not necessary for the reading units to be located on all sides of the object. In order to ensure that all sides of the object are read, the recognition station may include means for turning or rotating the objects so that two or three reading units together with one appropriate turning or rotating unit are sufficient for detecting all sides of an object. A person skilled in the art is capable of providing turning and/or rotating units within the scope of the present invention appropriate for detecting shipment data.

In one embodiment, the computer system is provided for evaluating the newly detected shipment data transmitted by the recognition station and checking for completeness and/or consistency thereof. Evaluation is performed e.g. by allocating the detected shipment data to certain shipment categories, such as first name and family name of the recipient for example, the associated street name, post code, city, and corresponding details for the sender. When the existing data is checked for completeness, the existing data regarding the respective shipment categories is checked. Herein, certain details may be missing, e.g. a city is specified in the delivery address, but the associated post code is missing. Also, parts of the name may be missing, i.e. first name or family name. Every piece of information required or useful for the delivery (distribution) of an object may represent a specific shipment category. The data in all of the shipment categories together amounts to all of the shipment data. In this case, for successful delivery, it is not necessary that all shipment categories be filled with data. When consistency of the shipment data is checked, possible contradictions in the shipment data are recognized and assessed. E.g., the specified post code might not match the specified city. In this case, the post code may be given priority over the city name. Based on experience with such inconsistencies, usually the wrong city was specified for the correct post code.

In a preferred embodiment, the computer system is provided for comparing the transmitted newly detected shipment data in case of incompleteness or inconsistency at least with the shipment data existing in the database and for completing and/or correcting the newly detected shipment data. The search for existing shipment data in the database could result for instance in that the delivery address involved in den detected shipment data is already completely and correctly known in the database. In this case, the newly detected shipment data is completed and possibly corrected with the already existing shipment data available for this address. As already described above, it is also possible that when the post code specification is given priority in the shipment data, the wrong city belonging to the post code is overwritten (corrected) by the computer system. The information used for correcting and/or completing maybe on the one hand the shipment data already existing in the database as such data can be accessed easily. Additional information may also be obtained via databases with directories of inhabitants, site maps, servers with e-mail directories, or other additional information. For this purpose, the computer system may either access external databases having such data, or the database of the inventive system as such contains such additional information.

In one embodiment, the computer system is provided for determining for each possible completion and/or correction a probability of the correctness of the possible completion and/or correction, and for executing the completion and/or correction only for a probability above a threshold. Such a threshold can e.g. be a probability greater than 80%, preferably greater than 90%, and more preferably greater than 95%. An estimate of the probability can e.g. be made from the ratio of the number of consistencies in individual shipment categories for known shipment data to a total number of shipment data for the region involved where the recipient is searched.

In one embodiment, if checking of the newly detected shipment data is successful, the computer system is provided for allocating the newly detected shipment data or the completed and/or corrected shipment data to the corresponding object and for storing them in the database. Such allocated shipment data can then also be used for later checks as part of the database.

In one embodiment, the computer system is provided for establishing possible second route plans taking into account the object with newly detected shipment data for all transport vehicles with first route plans, and selecting according to predefined criteria the most suitable one of all second route plans, and allocating the object to the transport vehicle with the most suitable second route plan. Herein, it is checked for all transport vehicles in how far the newly added object fits into the original first route plan, without having to perform unacceptable modifications to the original first route plan for the subsequent second route plan. In this respect, possible criteria could be route duration, route length, fuel consumption of the transport vehicle, degree of utilization of the available transport capacity (size of the transport vehicle) etc. For the most suitable route with such criteria to be determined, locations where the quantities involved are minimal or maximal are looked for. The transport vehicle with the most suitable route plan is allocated to the originally unplanned object.

In another embodiment, if newly detected shipment data is not successful, the computer system is provided for having the corresponding object removed from the means of conveyance prior to loading into a transport vehicle by driving an appropriate sorting means. Thus, at an appropriate location, the unplanned object not allocated can be removed from the process flow with little effort and taken into account for later transports when the shipment data has been determined.

The invention also involves a method for route planning for transport vehicles and for loading the transport vehicles with objects to be transported, wherein the objects to be transported are allocated shipment data in a computer system with a database, comprising the steps of:
creating a first route plan allocated for each transport vehicle for the objects to be delivered on a date of distribution with the respective transport vehicle by means of the shipment data allocated to the objects,
conveying the objects to be transported according to the first route plan to the allocated transport vehicles via a means of conveyance,
checking by means of a checking station whether a first route plan exists for the respective objects passing through the checking station while being conveyed to the transport vehicles,
emitting a corresponding error signal by the checking station in case of a non-existent first route plan,
detecting the shipment data by means of appropriate detecting means in a recognition station based on the error signal for the object involved without a first route plan,
transmitting such newly detected shipment data to the computer system,
allocating the object with newly detected shipment data while it is being conveyed by the means of conveyance to the appropriate transport vehicles by the computer system, and
converting the first route plan for this appropriate transport vehicle into a second route plan taking into account the object with newly detected shipment data.

In one embodiment, the method further includes the steps of:
evaluating the detected shipment data transmitted from the recognition station by the computer system, and
checking the newly detected shipment data for completeness and/or consistency by the computer system.

In another embodiment, the method further includes the steps of:
comparing the transmitted newly detected shipment data, in case of incompleteness or inconsistency, at least with existing shipment data in the database by the computer system,
completing and/or correcting the newly detected shipment data by the computer system; preferably, for each possible completion and/or correction, a probability of the correctness of the possible completion and/or correction is determined, and the completion and/or correction is performed only for a probability above a threshold.

In another embodiment, the method further includes the steps of:
allocating the newly detected shipment data to the corresponding object if the shipment data have been successfully checked and stored in the database by the computer system, or
driving an appropriate sorting means by the computer system for removing the corresponding object from loading of the means of conveyance in a transport vehicle if the newly detected shipment data have not been checked successfully.

In another embodiment of the method, the step of converting the first route plan into a second route plan comprises creating possible second route plans taking into account the object with newly detected shipment data for all transport vehicles with first route plans, and selecting the most suitable one of all possible second route plans according to predefined criteria, and allocating the object to transport vehicle with the most suitable second route plan by the computer system.

### BRIEF DESCRIPTION OF THE DRAWINGS

The above and other aspects of the present invention are represented in detail in the drawings.

FIG. 1 shows an embodiment of the inventive system.

FIG. 2 shows an object with shipment data and route label.

FIG. 3 shows an embodiment of the inventive method.

### DETAILED DESCRIPTION OF EMBODIMENTS

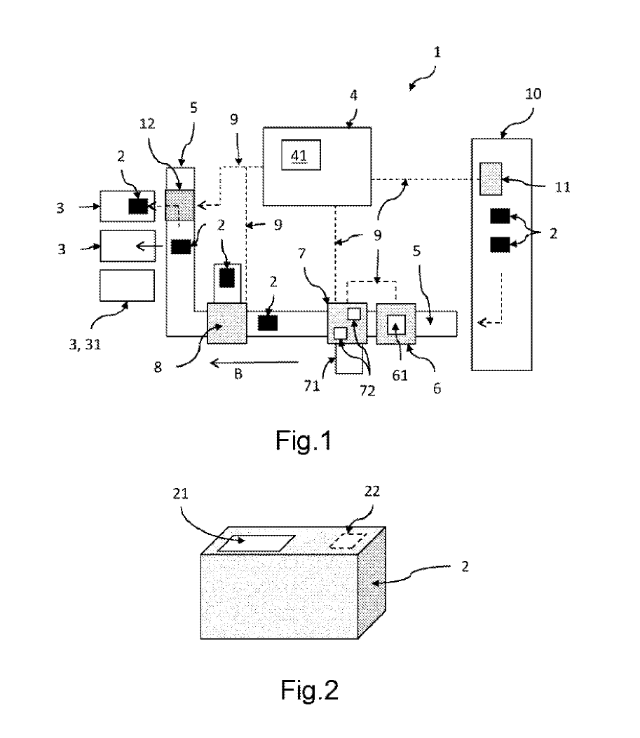

FIG. 1 shows an embodiment of a system 1 for route planning for transport vehicles 3 and for loading the transport vehicles 3 with objects to be transported 2. For this purpose, the system 1 includes a computer system 4 with a database 41 where shipment data allocated to the objects 2 is stored, e.g. for object-1 information on sender-1, invoice recipient-1, recipient-1, contact person-1 of the sender, the recipient, or the invoice recipient, details-1 on the content of the shipment, details-1 on features of the shipment (e.g. size, weight, fragility, etc.), information on desired additional services (e.g. special delivery times) as well as shipment identification details, or for object-2 information on sender-2, invoice recipient-2, recipient-2, contact person-2 of the sender, the recipient, or the invoice recipient, details-2 on the content of the shipment, details-2 on features of the shipment (e.g., size, weight, fragility, etc.), information on desired additional services (e.g., special delivery times) as well as shipment identification details.

By means of the shipment data allocated to the objects 2, the computer system 4 creates for each transport vehicle 3 an allocated first route plan T1 including the list of objects 2 to be delivered on a certain date of distribution, possibly also at a certain time, in the specific transport vehicle 3. According to the route plan, the objects 2 are conveyed from a warehouse 11 via a means of conveyance 5, herein a conveyor belt 5, to the allocated transport vehicles 3. Loading the transport vehicles 3 with the objects 2 planned therefor is done by a loading station 12 existing e.g. for each transport vehicle. In FIG. 1, only one loading station 12 is explicitly represented for the sake of simplicity. The computer system 4 drives via a data connection 9 the loading of the objects 2 by means of the first (and possibly second) route plans into the planned transport vehicles 3 via the loading station 12. A person skilled in the art is aware of appropriate loading stations 12 for computer-controlled loading. In this respect, computer control can be e.g. sending the route plan applicable to transport vehicle 3 corresponding to a loading list. Alternatively, recognizing the object 2 at the loading station 12 with subsequent querying of the loading station 12 at the computer system 4 or by the loading station accessing a current loading list (e.g. as a look-up table) provided by the computer system 4, loading into the allocated route vehicle 3 can take place.

In order to ensure that a route plan exists for all of the objects 2 conveyed on the conveyor belt 5, a checking station 6 is arranged in the conveyor belt 5. By means of one or several checking means 61, the checking station 6 reads the shipment data or other information available on the object 2, e.g. a route label, and therefore knows whether a first route plan exists for the respective objects 2. In this case, the objects 2 are further conveyed B into the planned transport vehicles 3 via the conveyor belt 5 and the loading stations 12. In the event of a non-existent first route plan, the checking station 6 sends a corresponding error signal FS, either to the computer system 4 for retransmission and treatment, or directly to a recognition station 7 via a data connection 9, so that the shipment data of the object 2 involved without a first route plan can be detected by means of one or several appropriate detecting means 71. Appropriate detecting means 71 are e.g. reading units for optical character recognition and/or barcode recognition. In addition, the recognition station 7 may comprise means for rotating and/or turning the objects 2 so that all sides of the object can be read by the reading unit 71.

The shipment data newly detected by the detecting station 7 is transmitted via a data connection 9 to the computer system 4, and allocated to an appropriate transport vehicle 31 during the duration of conveyance to the transport vehicles 3. Accordingly, the first route plan for this transport vehicle 31 is converted by the computer system 4 into a second route plan where the object 2 is taken into account with the newly detected shipment data. Before the objects 2 have reached the loading stations 12, a sorting means 8 is arranged in the conveyor belt 5. The sorting means 8 prevents objects from reaching the loading stations which, after the newly detected shipment data have been checked and evaluated by the computer system 4, cannot be allocated to any transport vehicle 3. This would interfere with the process flow at the loading stations 12, and cause an unnecessary amount of work for removing this object 2 from the conveyor belt 5 or a transport vehicle 3.

FIG. 2 shows an object 2 with shipment data 21 and with a route label 22 applied by the labeling unit 11 as a sticker. Here, the existence of a first route plan for the respective object 2 is documented by the existing route label 22. For this purpose, e.g. in the warehouse 10, a labeling unit 11 is arranged for applying a route label to objects 2 arriving at the warehouse. The computer system is connected via a data connection 9 to the labeling unit 11 for the corresponding control of creating route labels 22.

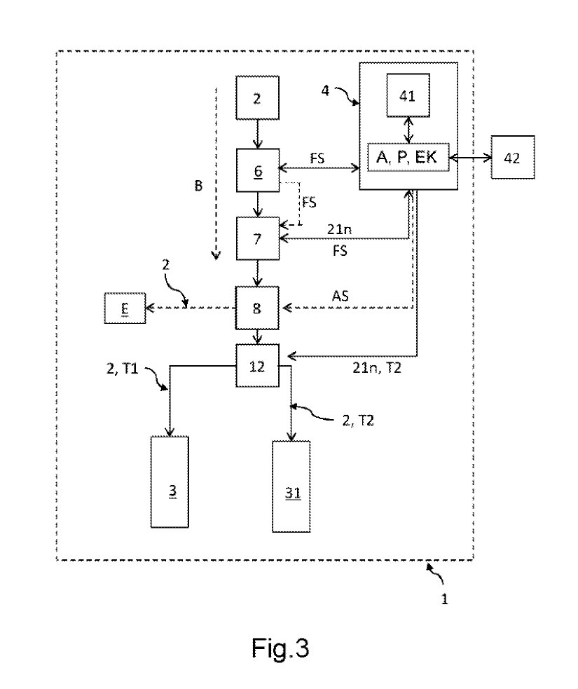

FIG. 3 shows an embodiment of the inventive method, where objects 2, as already shown in FIG. 1, pass by a checking station 6 in order to check for the existence of a first route plan T1. If this first route plan T1 exists, then the object 2 involved is conveyed B according to the first route plan T1 to the allocated transport vehicle 3. In the event of non-existence of a first route plan T1 for the object 2 checked, a corresponding error signal FS is emitted by the checking station 6, in this embodiment via the computer system 4. The computer system 4 retransmits the error signal FS to the recognition station 7 for the recognition station 7 to detect the shipment data of the unplanned object 2 by means of appropriate detecting means 71 based on the error signal FS for the object involved 2 without a first route plan T1. The shipment data 21n, now newly detected, is transmitted from the recognition station 7 to the computer system 4 for the computer system 4 to evaluate A the newly detected shipment data 21n and checked P for completeness and/or consistency. In case of incompleteness or inconsistency of the newly detected shipment data 21n, the computer system 4 compares such shipment data 21n at least with the shipment data 21 existing in the database 41 and completes and/or corrects them. For completing and/or correcting EK, the computer system may also make use of data from external databases 42 to which the computer system is connected via a data connection, e.g. via a server and an internet connection. In order for a reliable completion and/or correction EK to be performed, for each possible completion and/or correction EK, a probability of the correctness of the possible completion and/or correction EK is determined, and the completion and/or correction EK is performed only for a probability above a threshold (S), e.g. greater than 80%, greater than 90% or greater than 95%. If checking P is successful, then the newly detected shipment data 21n or the completed and/or corrected EK shipment data 21n is allocated to the corresponding object 2 and stored in the database 41. Furthermore, the object 2 with newly detected shipment data 21n is allocated during continuous conveyance B along the means of conveyance 5 to an appropriate transport vehicle 31 by the computer system 4, and the first route plan T1 for this appropriate transport vehicle 31 is converted into a second route plan T2. The second route plan T2 is transmitted to the loading stations 12 as above.

If checking P fails, then the newly detected shipment data 21n controls AS the computer system 4 via a data connection of an appropriate sorting means 8 for removing E the corresponding still unplanned object 2 before the still unplanned object 2 reaches any of the loading stations 12.

The detailed representation of the invention in this section and in the figures is an example for possible embodiments within the scope of the invention and therefore are not be construed as limiting the same. Consequently, all quantities mentioned are to be understood only as an example of certain embodiments.

Alternative embodiments, which a person skilled in the art may take into consideration within the scope of the present invention, are also included in the scope of protection of the present invention. In the claims, terms such as “a, an” also include the plural form. Reference symbols mentioned in the claims are not to be construed as a limitation.

### REFERENCE LIST

1 system
2 objects
21 shipment data
21n newly detected shipment data
22 route label
3 transport vehicles
31 transport vehicle with the most suitable second route plan
4 computer system
41 database
42 external database
5 means of conveyance
6 checking station
61 checking means
7 recognition station
71 detecting means, reading unit
72 sorting device of the recognition station
8 sorting device
9 data connections
10 warehouse for objects
11 labeling unit
12 loading station
A evaluating the transmitted newly detected shipment data
P checking the transmitted newly detected shipment data
B conveying the objects with a means of conveyance
E removing an object from the means of conveyance
EK completing and/or correcting the newly detected shipment data
FS error signal
AS sorting signal
T1 first route plan
T2 second route plan

1. A system for route planning for transport vehicles and for loading the transport vehicles with objects to be transported, the system comprising a computer system having a database with shipment data allocated to the objects to be transported, the computer system creating by means of the shipment data allocated to the objects for each transport vehicle an allocated first route plan for the objects to be delivered on a date of distribution with the respective transport vehicle, and the system comprising a means of conveyance, preferably a conveyor belt, conveying the objects to be transported according to the route plan to the allocated transport vehicles,
wherein
the system further includes a checking station and a recognition station, wherein the checking station is provided for checking whether a first route plan exists for the respective objects passing by the checking station while being conveyed to the transport vehicles, and in the event of a non-existent first route plan, provided for emitting a corresponding error signal,
the recognition station is provided for detecting, based on the error signal, the shipment data for the object involved without a first route plan by means of appropriate detecting means, and transmitting such newly detected shipment data to the computer system, and
the computer system is provided for allocating the object with newly detected shipment data to an appropriate transport vehicle, while it is being conveyed by the means of conveyance to the transport vehicles, and according to the transmitted new shipment data converting the first route plan for this transport vehicle into a second route plan where the object with newly detected shipment data is taken into account.

2. The system according to claim 1, characterized in that the objects with an allocated first route plan include a corresponding machine readable route label to be read by the checking station.

3. The system according to claim 1, wherein the detecting means includes at least one reading unit for optical character recognition and/or barcode recognition.

4. The system according to claim 3, wherein the recognition station includes several reading units, wherein the reading units are arranged so that the optical characters and/or barcodes can be detected on all sides of the object.

5. The system according to claim 1, wherein the computer system is provided for evaluating the newly detected shipment data transmitted by the recognition station and checking for completeness and/or consistency thereof.

6. The system according to claim 5, wherein the computer system is provided for comparing the transmitted newly detected shipment data, in case of incompleteness or inconsistency, at least with shipment data existing in the database, and completing and/or correcting the newly detected shipment data.

7. The system according to claim 6, wherein the computer system is provided for determining, for each possible completion and/or correction, a probability of the correctness of the possible completion and/or correction, and performing the completion and/or correction only for a probability above a threshold.

8. The system according to claim 5, wherein, if checking of the newly detected shipment data was successful, the computer system is provided for allocating the newly detected shipment data or the completed and/or corrected shipment data to the corresponding object and storing the same in the database.

9. The system according to claim 8, wherein the computer system is provided for creating a possible second route plan taking into account the object with newly detected shipment data for all transport vehicles with first route plans, and selecting according to predefined criteria the most suitable of all second route plans, and allocating the object to the transport vehicle with the most suitable second route plan.

10. The system according to claim 5, wherein, if checking of the newly detected shipment data is not successful, the computer system is provided for removing the corresponding object from the means of conveyance before loading the same into a transport vehicle, by driving an appropriate sorting means.

11. A method for route planning for transport vehicles and loading the transport vehicles with objects to be transported, wherein the objects to be transported are allocated shipment data in a computer system having a database, comprising the steps of:
creating a first route plan allocated to each transport vehicle for the objects to be delivered on a date of distribution with the respective transport vehicle by means of the shipment data allocated to the objects,
conveying (B) the objects to be transported according to the first route plan to the allocated transport vehicles via a means of conveyance,
checking by means of a checking station whether a first route plan exists for the respective objects passing by the checking station while being conveyed (B) to the transport vehicles,
emitting a corresponding error signal in the event of a non-existent first route plan by the checking station,
detecting the shipment data by means of appropriate detecting means in a recognition station based on the error signal for the object involved without a first route plan,
transmitting the newly detected shipment data to the computer system,
allocating the object with newly detected shipment data, while it is being conveyed with the means of conveyance to the appropriate transport vehicles, by the computer system, and
converting the first route plan for this appropriate transport vehicle into a second route plan taking into account the object with newly detected shipment data.

12. The method according to claim 11, further comprising the steps of:
evaluating the newly detected shipment data transmitted from the recognition station by the computer system, and checking the newly detected shipment data for completeness and/or consistency by the computer system.

13. The method according to claim 12, further comprising the steps of:
comparing the transmitted newly detected shipment data in case of incompleteness or inconsistency at least with existing shipment data in the database by the computer system,
completing and/or correcting the newly detected shipment data by the computer system; preferably for each possible completion and/or correction, a probability of the correctness of the possible completion and/or correction is determined, and the completion and/or correction is performed only for a probability above a threshold.

14. The method according to claim 12, further comprising the steps of:
allocating the newly detected shipment data to the corresponding object if checking was successful and storing the shipment data in the database by the computer system, or
driving an appropriate sorting means by the computer system for removing the corresponding object before loading the same into a transport vehicle from the means of conveyance if checking of the newly detected shipment data was not successful.

15. The method according to claim 11, wherein the step of converting the first route plan into a second route plan includes creating possible second route plans taking into account the object with newly detected shipment data for all transport vehicles with first route plans, and selecting the most suitable of all possible second route plans according to predefined criteria, and allocating the object to the transport vehicle with the most suitable second route plan by the computer system.
